(19) United States
(12) Patent Application Publication
(10) Pub. No.: US 2017/0351876 A1
(43) Pub. Date: Dec. 7, 2017

(54) VERIFICATION SYSTEM, INFORMATION PROCESSING APPARATUS, AND VERIFICATION METHOD

(71) Applicants: Masuyoshi YACHIDA, Tokyo (JP); Hitoshi NAMIKI, Kanagawa (JP); Hiroshi KOBAYASHI, Kanagawa (JP); Ryouji YAMAMOTO, Kanagawa (JP)

(72) Inventors: Masuyoshi YACHIDA, Tokyo (JP); Hitoshi NAMIKI, Kanagawa (JP); Hiroshi KOBAYASHI, Kanagawa (JP); Ryouji YAMAMOTO, Kanagawa (JP)

(73) Assignee: Ricoh Company, Ltd., Tokyo (JP)

(21) Appl. No.: 15/604,735

(22) Filed: May 25, 2017

(30) Foreign Application Priority Data
Jun. 3, 2016 (JP) 2016-112193

(51) Int. Cl. G06F 21/64; H04L 29/06

(52) U.S. Cl. CPC G06F 21/64; H04L 63/123

(57) ABSTRACT

A verification system for verifying attribute information included in attribute-information-added information includes circuitry to acquire attribute verification data from the attribute information, the attribute verification data to be used for verifying the attribute information, acquire public information, to be used for verifying the attribute information, from an external service provider, generate verification-target information to be used for verifying the attribute information based on the attribute information and the attribute verification data, and determine reliability of the attribute information by comparing verification-use information calculated from the acquired public information and the verification-target information.

### CROSS-REFERENCE TO RELATED APPLICATION

This application claims priority pursuant to 35 U.S.C. §119(a) to Japanese Patent Application No. 2016-112193, filed on Jun. 3, 2016 in the Japan Patent Office, the disclosure of which is incorporated by reference herein in its entirety.

### BACKGROUND

### Technical Field

This disclosure relates to a verification system, an information processing apparatus, and a verification method.

### Background Art

Along with lower price and higher functionality of image capture devices such as cameras, the image capture devices are installed in various locations or places, and images captured by the image capture devices under various scenes are used for various purposes. For example, an image captured by an image capture devices is used as evidence of a trial. Further, for example, the state of interrogation is recorded on a recording medium such as a digital versatile disk (DVD) and is submitted as evidence as necessary. Further, images captured by surveillance cameras and taxi drive recorders can be also used admissible evidence having the competence of evidence.

On the other hand, when an image captured by the image capture device is used as an admissible evidence, threat such as falsification, manipulation, alteration, or modification may occur to images and attribute information of images (e.g., image captured time, image captured location). If the falsification, manipulation, alteration, or modification of images and attribute information is detected, it becomes difficult to submit images as admissible evidence having the competence of evidence.

As a method for preventing falsification, manipulation, alteration, or modification of images and attribute information, for example, the image capture device and the like assigns or sets an electronic signature to images. By verifying the electronic signature using some apparatuses, it can be determined that the image is not falsified, manipulate, alternated, or modified.

However, the method that assigns the electronic signature to the image may not guarantee the accuracy of attribute information. Even though the image capture device can assign the electronic signature to the attribute information as well as the image, if the attribute information has been falsified, manipulated, altered, or modified before assigning the electronic signature (i.e., incorrect attribute information is assigned), the electronic signature becomes a signature set to the attribute information.

For example, when an image is captured by an image capture device, and an electronic signature can be assigned to the image by the image capture device, the image capture device can assign or set the electronic signature to internal time information of the image capture device used as the attribute information of the image. However, if the internal time information of the image capture device is incorrect information, it will not prove that the time information is correct even if the electronic signature is assigned to the internal time information.

In view of such issue, JP-2015-152398-A discloses a technique that can easily estimate reliability of information associated to an image capturing. JP-2015-152398-A discloses a display control device that assigns information indicating a type of satellite used for determining position information to image data.

However, even if the information indicating the type of satellite is included in the attribute information, the technique cannot determine whether the position information included in the attribute information is reliable or not. Specifically, even if the information of satellite used for the global positioning system (GPS) is included in the attribute information, it does not guarantee that the position information is calculated using electromagnetic wave transmitted from the satellite.

### SUMMARY

As one aspect of present disclosure, a verification system for verifying attribute information included in attribute-information-added information is devised. The verification system includes circuitry to acquire attribute verification data from the attribute information, the attribute verification data to be used for verifying the attribute information, acquire public information, to be used for verifying the attribute information, from an external service provider, generate verification-target information to be used for verifying the attribute information based on the attribute information and the attribute verification data, and determine reliability of the attribute information by comparing verification-use information calculated from the acquired public information and the verification-target information.

As another aspect of present disclosure, an information processing apparatus to verify attribute information included in attribute-information-added information is devised. The information processing apparatus includes circuitry to acquire attribute verification data from the attribute information, the attribute verification data to be used for verifying the attribute information, acquire public information, to be used for verifying the attribute information, from an external service provider, generate verification-target information to be used for verifying the attribute information based on the attribute information and the attribute verification data, and determine reliability of the attribute information by comparing verification-use information calculated from the acquired public information and the verification-target information.

As another aspect of present disclosure, a method of verifying attribute information included in attribute-information-added information is devised. The method includes acquiring attribute verification data from the attribute information, the attribute verification data to be used for verifying the attribute information, acquiring public information, to be used for verifying the attribute information, from an external service provider, generating verification-target information to be used for verifying the attribute information based on the attribute information and the attribute verification data, and determining reliability of the attribute information by comparing verification-use information calculated from the acquired public information and the verification-target information.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 illustrates an example of a schematic configuration of a verification system of an embodiment of the present invention;

FIG. 2 is an example of a hardware block diagram of an image capture device;

FIG. 3 is an example of a hardware block diagram of a verification apparatus;

FIG. 4 is an example of a functional block diagram of the image capture device;

FIG. 5 is an example of a sequential chart of assigning or setting an electronic signature to attribute verification data by the image capture device;

FIG. 6 is a schematic example of attribute verification data and electronic signature data;

FIG. 7 is an example of a sequential chart of an operation procedure of the image capture device when the image capture device captures an image;

FIG. 8 illustrates a schematic example of transmission data of a movie image applying the motion picture encoding/decoding system of H.264;

FIG. 9 is a schematic example of transmission data of a still image, in which attribute information is set to image data;

FIG. 10 is an example of a functional block diagram of the verification apparatus;

FIG. 11 is an example of a flow chart illustrating the steps of verifying attribute information by the verification apparatus; and

FIG. 12 illustrates an example of a position of a satellite at a specific position measurement time point estimated by applying public information and a position of the satellite at a specific position measurement time point estimated by applying attribute verification data.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of present disclosure. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of present disclosure.

In addition, it should be noted that the terminology used herein is for the purpose of describing particular embodiments only and is not intended to be limiting of present disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps; operations, elements, components, and/or groups thereof.

Furthermore, although in describing views illustrated in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more embodiments are described hereinafter.

A description is given of embodiments of the present invention with reference to drawings. As described in this disclosure, an image capture device of an embodiment can set attribute information in a way that reliability of the attribute information can be verified. Specifically, the attribute information is set so that a verification apparatus can verify that correct time information and correct position information are set. As for images, it is guaranteed that the images are not falsified, manipulated, altered, or modified by separately setting an electronic signature. Therefore, the attribute information can guarantee that the position and time when the image was captured are reliable.

At first, a description is given of a conventional technique to improve reliability of attribute information. For example, when an image capture device captures an image, an electronic signature is assigned to attribute information, in which the image capture device assigns the electronic signature by setting internal time information, internally set in the image capture device, as the attribute information of the image by using the Real Time Clock (RTC). However, even if the electronic signature alone can guarantee that the time information is not falsified, manipulated, altered, or modified, a verification apparatus cannot determine whether the time information having reliability is actually stored in the attribute information.

Further, a Network Time Protocol (NTP) service that delivers correct time information is present, for example, on the Internet. The image capture device can synchronize the internal clock held by the image capture device with the NPT server. However, it cannot guarantee that malicious operators and malicious software did not falsify, manipulate, alter, or modify the time information of the internal clock of the image capture device.

Further, image capture devices equipped with the function of the global positioning system (GPS) are also available. However, even if position information and time information calculated using the GPS function are assigned to the image as the attribute information, and then the image capture device sets an electronic signature to the attribute information, it cannot guarantee that the attribute information was generated using the GPS function. For example, it cannot guarantee that malicious operators and malicious software did not falsify, manipulate, alter, or modify the time information and the position information generated by using the GPS.

Further, there is a method using an external server having higher reliability installed at an external site. In this case, an image capture device transmits images and feature of images and to the external server, and then the external server assigns an electronic signature to prove that the images existed at the time of capturing the images, which is known as the timestamp service. However, since the image capture device is required to access the external server such as a time server to acquire a timestamp while capturing images by the image capture device, an overhead becomes greater and time difference will occur, with which it is difficult to acquire the timestamp while capturing the images.

Further, a technology that an external server having reliability transmits time information assigned with an electronic signature to guarantee accuracy of the set time information is known. However, such service is not actually available.

### (Outline of Method of Setting Attribute Information)

In view of issues of conventional technologies, an embodiment of the present invention is devised, in which a method of verifying reliability of attribute information assigned to an image by an image capture device by using public information is devised. Typically, as to a service system that provides information having higher publicness, an operation status of the service system is recorded to guarantee reliability of information, and information indicating that the service system was operated normally at a specific time is open to public, which means the information indicating that the service system was operated normally at the specific time is publicly available. The service system include, for example, a NTP server and a global positioning system (GPS) that can provide accurate time information, in which information indicating the service system was operated normally at the specific time is open to public, and information that can be used for verification is open to public. Therefore, if an apparatus such as an image capture device have acquired data from one service system, known to public, at a specific time point, and the image capture device sets attribute information for an image captured by the image capture device by including the data acquired from the one service system in the attribute information, the verification apparatus can verify reliability of the attribute information by applying public information available from the one service system.

In an embodiment of the present invention, when an image capture device generates the attribute information such as time information and position information by using one service system for an image captured by the image capture device, the image capture device retains or stores data (i.e., attribute verification data to be described later) acquired from the one service system. Then, the verification apparatus generates verification-target information by using the data acquired from the one service system and the attribute information, and compares the verification-target information and verification-use information, generatable from public information provided to public by the one service system and can be used for a verification process, to verify reliability of the attribute information.

### (Outline of Procedure)

### (1: Acquiring Reliable and Less Expensive Attribute Information)

An image capture device can measure a position on the earth by using a position information providing service using satellites such as the global navigation satellite system (GLASS) including the global positioning system (GPS). Further, the position information providing service also delivers time information and accuracy (error ellipse) of information of satellites used for a position measurement process. Further, the position information providing service discloses precise orbit information of each satellite so that positions of each of the satellites at a specific time point can be calculated. The image capture device compatible with the GPS can acquire these information at low cost. Further, various types of NTP servers synchronized with standard time are available for use, and the image capture device compatible with the NTP server can acquire correct time information through the Internet at low cost.

### (2: Setting Attribute Information by Reliable Method)

By using various services indicated in (1), the image capture device can acquire correct attribute information. For example, the image capture device can correct time information used internally in the image capture device based on the correct attribute information. Further, the image capture device can set correct position information for the image capture device. In particular, since the time information of GPS using the atomic clock is very accurate, and is delivered directly to the image capture device by electromagnetic waves, the time information can be set with lesser error.

### (3: Recording of Attribute Information Setting)

Conventionally, when data is acquired from the GPS or NTP server, information necessary for attribute information (e.g., time information and position information of GPS) is extracted, and the extracted information is set for the image capture device. However, a setting method of the time information and the position information is not clearly known by simply setting the time information and the position information. Therefore, in the embodiment, the image capture device keeps or retains data used for setting the time information and the position information, in which the data used for setting the time information and the position information is referred to as attribute verification data.

### (4: Protection of Attribute Verification Data)

When the attribute verification data is not protected, it may be changed or destroyed for some reasons. Therefore, the image capture device retains or keeps records indicating when and how the image capture device sets the attribute information based on what data, and further, the image capture device protects the attribute verification data by assigning an electronic signature to the attribute verification data.

### (5: Setting Attribute Verification Data to Image)

When the image capture device assigns or sets attributes such as the acquired time information and position information to images, the image capture device sets the attribute verification data to the image. The setting of attribute verification data means that accompanying, associating, attaching, or integrating the attribute verification data with image data while the attribute verification data can be retrieval from the image data. When the image data is transferred to a client that uses the image data by a file transfer or stream transfer, the attribute verification data is also transferred to the client with the image data.

### (6: Verification of Attribute Information)

When a verification apparatus acquires the image data from the image capture device, the verification apparatus also acquires the attribute information including the attribute verification data assigned to the image data, and then the verification apparatus verifies the attribute information by using public information that is publicly available from the one specific service system. As a result, the verification apparatus can determine that the attribute information was calculated or set by a reliable method.

### (Terms)

The attribute-information-added information means information having attribute information that reliability of the attribute information is to be verified by a verification system of the embodiment. For example, in a case of image data, the attribute-information-added information means information having attribute information such as time information and position information. For example, the attribute-information-added information is electronic data such as document data, various application files, and experiment data or the like. In this description, image data is used as an example of the attribute-information-added information. In this description, the image data means movie images such as video and still images, and the image data is set with or without sound data.

The attribute information means information that is associated to image data or an image capturing method. Further, the attribute information means information set to the image data. Specifically, the attribute information set to the image data includes, for example, an image capturing position and an image capturing location or place. The attribute information can further include other information such as information of an image capture device used for an image capturing operation, image capturing conditions, and an image capture person.

The attribute verification data means information that can be used for a verification process of the attribute information, and the attribute verification data becomes various information depending on the attribute information. When the attribute information is, for example, position information, the attribute verification data means information that can be used for estimating a position of a satellite by using the position information set as the attribute information.

The verification-target information means information to be used for verifying the attribute information. For example, the verification-target information is information of a position of a satellite that is estimated from the position information and the attribute verification data.

The public information means information to be used for verifying the attribute information, wherein the public information is publicly available information. Therefore, various public information can be used depending on the attribute information. In this disclosure, when the attribute information is, for example, time information, public information is orbit information of a satellite used for calculating a position of the satellite at a time point corresponding to the time information.

The determining of reliability of the attribute information means to determine whether the attribute information is set by using a method having reliability. Further, in the determining process, it is also determined that the attribute information is correct or accurate such as an image was captured at the position included in the attribute information, and at the time point included in the attribute information. Further, if the attribute information is set with a method having reliability, it can be estimated that the attribute information is also correct or accurate.

The verification-use information means information that is calculated from the public information, and the verification-use information is compared with the verification-target information. In this disclosure, when the attribute information is, for example, time information, the verification-use information is information of a position of a satellite calculated from the public information at a time point corresponding to the time information set as the attribute information.

The reliable method means an acquisition method, a calculation method and a setting method of attribute information having a given level of guaranteed accuracy. Specifically, the reliable method includes, for example, a position measurement method and a time delivery method using the GPS that can perform a satellite-based a position measurement process, and a time providing method by using the NTP server.

### (System Configuration)

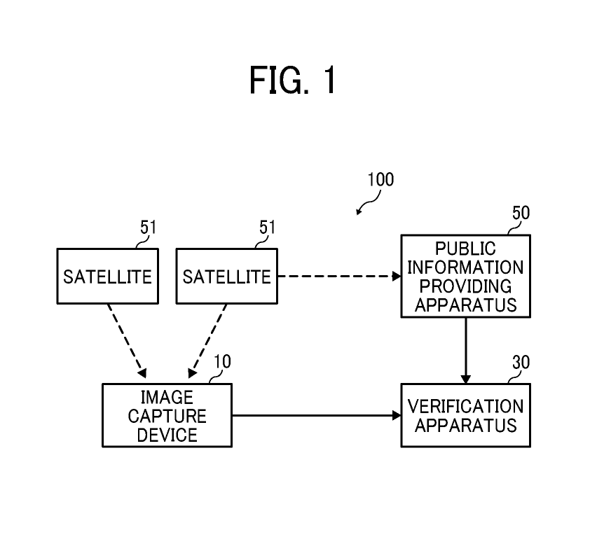

FIG. 1 illustrates an example of a schematic configuration of a verification system 100 of an embodiment of the present invention. As illustrated in FIG. 1, the verification system 100 includes, for example, an image capture device 10, a public information providing apparatus 50, and a verification apparatus 30. The image capture device 10 captures images and stores captured images. The image includes any kinds of image including still pictures and movie images with or without other data such as sound data. The image capture device 10 is, for example, a digital still camera, a digital video camera or the like. Further, the image capture device 10 can be configured to capture images alone without storing the captured images, in which the image capture device 10 may be, for example, a smartphone, a tablet terminal, a mobile phone, a personal digital assistant (PDA), a personal computer (PC), a game machine, a navigation device, a television conference terminal, an electronic information board, a multifunctional machine, and a projector.

The image capture device 10 acquires current time information from electromagnetic waves received from a satellite 51 such as a global positioning system (GPS), in which the number of the satellites may be changed. Further, the image capture device 10 generates position information by performing a position measurement process using the acquired electromagnetic waves, and set the time information and position information as the attribute information of the image data. Further, the image capture device 10 sets the attribute verification data used for generating the position information to the attribute information. Further, the position information providing service is not limited to the GPS, but Galileo, quasi-zenith satellite system or the like can be used. In the embodiment, the position information providing service other than the GPS can be used.

When the time information and the position information are assigned to the image data as the attribute information, the image data assigned with the attribute information is transmitted to the verification apparatus 30 via an online transmission. For example, the online transmission can be a transmission via a network. When the image capture device 10 is present outdoors, the image capture device 10 transmits the image data using a mobile phone network such as the long term evolution (LTE), 3G, and 4G. Further, the image capture device 10 can transmit the image data using a public wireless LAN provided for outdoors. Further, when the image capture device 10 is present indoors, the image capture device 10 communicates with the verification apparatus 30 by connecting the image capture device 10 to the Internet via a wireless LAN or a wired LAN. When the image capture device 10 is present indoors, the image capture device 10 can transmit the image data using a mobile phone network such as LTE, 3G, and 4G.

Further, the image capture device 10 can store the image data in a storage or recording medium detachably attached to the image capture device 10. In this case, a user moves to the verification apparatus 30 with the storage medium and sets the storage medium to the verification apparatus 30, and then the verification apparatus 30 reads the image data stored in the storage medium. Therefore, even if the image capture device 10 and the verification apparatus 30 cannot communicate with each other directly (i.e., offline), the verification apparatus 30 can verify information associated to the image data.

The public information providing apparatus 50 monitors and records an operation status of the position information service. The operation status includes, for example, a status of the satellite 51 such as whether the satellite 51 has abnormality, and orbit information of the satellite 51 used for the GPS. The public information provided to public by the public information providing apparatus 50 can be used to verify the time information and the position information included in the attribute information.

The verification apparatus 30 verifies reliability of the time information and the position information set as the attribute information by using the public information provided to public by the public information providing apparatus 50. Specifically, the verification apparatus 30 determines whether information obtained by using the public information becomes equivalent to information obtained by using the time information and the position information and the attribute verification data. For example, the verification apparatus 30 estimates a position of the satellite 51 based on the time information and the position information by using the attribute verification data. Further, a position of the satellite 51 at a specific time point can be calculated from the public information such as orbit information of the satellite 51. If the position of the satellite 51 estimated from the time information and the position information and the position of the satellite 51 calculated from the public information (e.g., orbit information) of the satellite 51 can be assumed as the same, it can determine that the time information and the position information used for estimating the position of the satellite 51 have reliability.

### (Hardware Configuration of Image Capture Device)

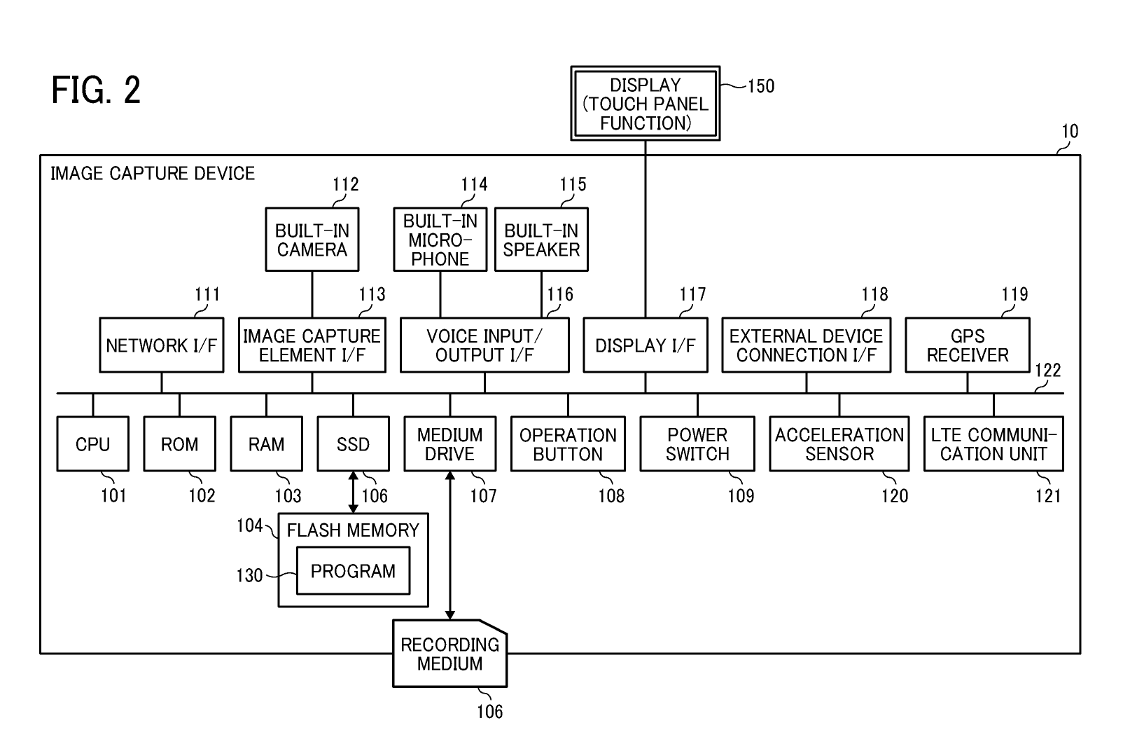

FIG. 2 is an example of a hardware block diagram of the image capture device 10. As illustrated in FIG. 2, the image capture device 10 includes, for example, a central processing unit (CPU) 101, a read only memory (ROM) 102, and a random access memory (RAM) 103. The CPU 101 controls an overall operation of the image capture device 10. The ROM 102 stores programs such as an initial program loader (IPL). The RAM 103 is used as a working area of the CPU 101. The image capture device 10 further includes, for example, a flash memory 104, and a solid state drive (SSD) 105. The flash memory 104 stores various data such as program 130 used by the image capture device 10 and image data. The SSD 105 controls reading and writing of various data to the flash memory 104 under the control of the CPU 101. The image capture device 10 further includes, a media drive 107, an operation button 108, a power switch 109, and a network interface (I/F) 111. The media drive 107 controls reading and writing (storing) of data with a recording medium 106 such as a flash memory. The operation button 108 receives various operations input to the image capture device 10. The power switch 109 switches ON/OFF of the power of the image capture device 10. The network I/F 111 is used for data transmission using a communication network wirelessly or by wire.

The image capture device 10 further includes, for example, a built-in camera 112, an image capture element I/F 113, a built-in microphone 114, and a built-in speaker 115. The built-in camera 112 captures an image of an object, and acquires image data under the control of the CPU 101. The image capture element I/F 113 controls driving of the built-in camera 112. The built-in microphone 114 is used for inputting sound. The built-in speaker 115 is used for outputting sound. The image capture device 10 further includes, for example, a sound input/output I/F 116, a display 117, and an external device connection I/F 118. The sound input/output I/F 116 processes the input and output of sound signals by using the microphone 114 and the speaker 115 under the control of the CPU 101. The display I/F 117 transmits image data to the display 150 under the control of the CPU 101. The external device connection I/F 118 is used to connect with various external devices. The image capture device 10 further includes, for example, a GPS receiver 119, an acceleration sensor 120, a long term evolution (LTE) communication unit 121, and a bus line 122. The GPS receiver 119 receives electromagnetic waves from the satellite 51 used for the GPS to detect a position of the image capture device 10 on the earth. The acceleration sensor 120 detects an acceleration occurring in the image capture device 10. The LTE communication unit 121 performs sound communication and data communication via a mobile phone network. The bus line 122 such as an address bus and/or a data bus electrically connects the above-mentioned units illustrated in FIG. 2.

The display 150 is, for example, a liquid crystal display and an organic electroluminescence (GEL) display. The display 150 provides a display area for displaying a menu operated by a user, captured images, messages, and the like. The display I/F 117 corresponds to the touch panel function of the display 150.

The built-in camera 112 includes a lens and a solid-state imaging device for converting light into electric charge to digitize an image of an object, and the solid-state imaging device is, for example, a complementary metal oxide semiconductor (CMOS), a charge coupled device (CCD) or the like.

Various external devices can be attached to the external device connection I/F 118 by using a universal serial bus (USB) cable. Further, for example, a short-distance wireless communication device such as Bluetooth (registered trademark) can be connected to the external device connection I/F 118.

Further, the program 130 is stored in the flash memory 104. Further, the program 130 can be downloaded from a server used for a program distribution service via the network I/F 111.

Further, the recording medium 106 is detachable from the image capture device 10. Further, the program 130 may be distributed by storing the program 130 in the recording medium 106.

### (Hardware Configuration of Verification Apparatus)

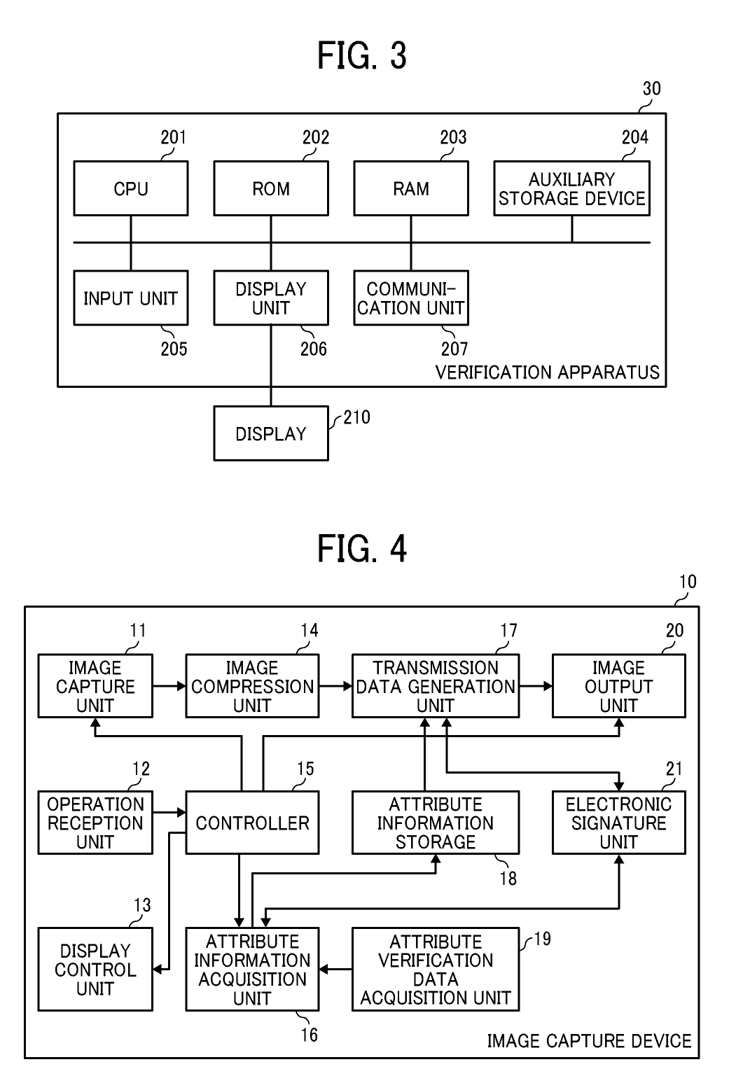

FIG. 3 is an example of a hardware block diagram of the verification apparatus 30. The verification apparatus 30 includes, for example, a CPU 201, a ROM 202, a RAM 203, and an auxiliary storage device 204. The verification apparatus 30 further includes, for example, an input unit 205, a display unit 206, and a communication unit 207. Further, each of the units of the verification apparatus 30 are connected via a bus 208. Therefore, the verification apparatus 30 can be used as an information processing apparatus.

The CPU 201 executes various programs and Operating System (OS) stored in the auxiliary storage device 204. The ROM 202 is a nonvolatile memory. The ROM 202 stores various programs and data necessary for the CPU 201 to execute various programs stored in the auxiliary storage device 204.

The RAM 203 is a main storage device such as a dynamic random access memory (DRAM) or a static random access memory (SRAM). When various programs stored in the auxiliary storage device 204 are executed by the CPU 201, various programs stored in the auxiliary storage device 204 are loaded on the RAM 203, in which the RAM 203 serves as a working area of the CPU 201.

The auxiliary storage device 204 stores various data bases to be used when various programs are executed by the CPU 201. The auxiliary storage device 204 is a non-volatile memory such as a hard disk drive (HDD) and a solid state drive (SSD).

The input unit 205 is an interface for an operator to input various instructions to the verification apparatus 30. For example, the input unit 205 is a keyboard, a mouse, a touch panel, a sound input device, and so on. Further, the input unit 205 can include a mounting portion of a recording medium such as a USB I/F.

The display unit 206 displays various information set for the verification apparatus 30 on the display 210 in the form of a cursor, a menu, a window, a character, and an image in response to a request from the CPU 201. The display unit 206 is, for example, a graphic chip and a display I/F.

The communication unit 207 is a network I/F that communicates with other devices via a network N.

The hardware configuration of the verification apparatus 30 of FIG. 3 is not necessary to be housed in one casing or provided as a single unit. The hardware configuration of the verification apparatus 30 of FIG. 3 indicates one hardware configuration employed for the verification apparatus 30. Further, to cope with cloud computing, the physical configuration of the verification apparatus 30 of the embodiment is not limited to one specific configuration, but can be changed, in which hardware resources can be dynamically connected or disconnected depending on the processing load.

### (Functional Block Diagram of Image Capture Device)

FIG. 4 is an example of a functional block diagram of the image capture device 10. As illustrated in FIG. 4, the image capture device 10 includes, for example, an image capture unit 11, an operation reception unit 12, a display control unit 13, an image compression unit 14, a controller 15, an attribute information acquisition unit 16, a transmission data generation unit 17, an attribute information storage 18, an attribute verification data acquisition unit 19, an image output unit 20, and an electronic signature unit 21.

Each of these functional units can be implemented by using the hardware elements illustrated in FIG. 2. For example, each of these functional units can be implemented when program loaded on the RAM 103 from the flash memory 104 are executed by the CPU 101 (FIG. 2) and then the CPU 101 instructs an operation to the hardware elements illustrated in FIG. 2. Further, a part or the entire of the functional units can be implemented by a hardware circuit such as integrated circuit (IC), large scale integrated circuit (LSI), application specific integrated circuit (ASIC), field-programmable gate array (FPGA) and the like.

The image capture unit 11 can be implemented when the CPU 101 (FIG. 2) executes programs and controls the built-in camera 112 and the image capture element I/F 113. The image capture unit 11 electrically acquires an image of an object and a scene within a range of an angle view of the image capture device 10, captured through a lens and formed on an image capture element, to generate image data. For example, the image capture unit 11 periodically generates image data during a movie image capturing mode, and generates image data each time a user operates the image capture device 10 during a still image capturing mode.

The operation reception unit 12 can be implemented when the CPU 101 (FIG. 2) executes programs and controls the touch panel and the operation button 108, and the operation reception unit 12 is used to receive a user operation to the image capture device 10.

The display control unit 13 can be implemented when the CPU 101 (FIG. 2) executes programs and controls the display I/F 117 to generate image data to be displayed on the display 150.

The image compression unit 14 can be implemented I/F the CPU 101 (FIG. 2) executes programs, and the image compression unit 14 compresses the image data generated by the image capture unit 11. The image data generated by the image capture unit 11 is, for example, RAW format data, and RGB format data. For example, the image compression unit 14 compresses the image data in a format such as JPEG in a case of still image, and the image compression unit 14 encodes the image data by using an encoding procedure such as H.264 and MPEG 2 in a case of movie image.

The transmission data generation unit 17 can be implemented when the CPU 101 (FIG. 2) executes programs, and the transmission data generation unit 17 generates transmission data from the compressed image data. For example, the transmission data generation unit 17 sets position information, time information and attribute verification data by using the EXIF format in a case of still image, and the transmission data generation unit 17 sets position information, time information and attribute verification data to, for example, a NAL unit complied with H.264 in a case of movie image.

The image output unit 20 can be implemented when the CPU 101 (FIG. 2) executes programs and controls the network I/F 111, and the image output unit 20 transmits image data to an external device or network. The image output unit 20 generates transmission data. For example, the image output unit 20 generates a header or the like in a case of still image to transmit the image data by using a protocol such as file transfer protocol (FTP) and hypertext transfer protocol (HTTP). In a case of movie image (streaming), the image output unit 20 generates image data using a specific streaming protocol such as HTTP streaming and Real-Time Streaming Protocol (RTSP). In the present disclosure, it is assumed that any kind of communication protocols can be used for transmitting data.

The attribute verification data acquisition unit 19 can be implemented when the CPU 101 (FIG. 2) executes programs and controls the GPS receiver 119, and the attribute verification data acquisition unit 19 acquires the attribute verification data. Further, the attribute verification data received by the GPS receiver 119 also includes, for example, position information and time information.

The attribute information acquisition unit 16 can be implemented when the CPU 101 (FIG. 2) executes programs, and the attribute information acquisition unit 16 acquires the attribute information such as position information and time information from the attribute verification data acquisition unit 19. The GPS receiver 119 acquires the position information and the time information with the attribute verification data. In other words, the attribute verification data includes the position information and the time information. In other words, the information received by the GPS receiver 119 includes the position information and the time information and the attribute verification data. The attribute information acquisition unit 16 outputs the attribute information including the position information, the time information, and the attribute verification data to the attribute information storage 18.

The attribute information storage 18 can be implemented when the CPU 101 (FIG. 2) executes programs and controls the SSD 105 and the RAM 103, and the attribute information storage 18 stores the attribute information in the RAM 103 and/or the flash memory 104.

The electronic signature unit 21 can be implemented when the CPU 101 (FIG. 2) executes programs, and electronic signature unit 21 assigns or sets an electronic signature to the transmission data to be transmitted by the transmission data generation unit 17.

The controller 15 can be implemented when the CPU 101 (FIG. 2) executes programs, and the controller 15 controls the overall operation of the image capture device 10.

(Operation for Acquiring Time Information and Position Information from Satellite))

For example, when distributing images captured by the image capture device 10 to a client (e.g., storage server) by using a streaming, the image capture device 10 spends most of the processing load for transferring image data. Therefore, the image capture device 10 acquires the attribute information in advance. In a case that the transferring of image data is segmented (e.g., image data is divided into several segments), the attribute information may be acquired between one segment and adjacent segment.

The attribute verification data acquisition unit 19 cooperates with the GPS receiver 119 to receive electromagnetic waves from the satellite 51 used for the GPS, and performs a positioning operation, and generates information associated to the satellite 51 such as time, position, and information of the satellite 51 used for the GPS that transmits electromagnetic waves. The generated information is used as, for example, the time information, the position information and the attribute verification data. In this disclosure, for example, the attribute verification data acquisition unit 19 generates information according to National Marine Electronics Association (NMEA) 0183. The NMEA 0183 is a communication protocol for serial communication of data. In general, the NMEA 0183 is used as a communication protocol for connecting the GPS receiver 119 and a control unit of a device such as a navigation device. Further, the NMEA 0183 is also used as a format for outputting data of marine electronic devices such as anemometer, gyro compass, and auto pilot. However, the NMEA 0183 is widely used not only at sea. Further, NMEA 0182 can be used as a communication protocol.

For example, the standard output of NMEA 0183 includes messages of GNS/GGA, GST, GSA, GSV, and ZDA. The GNS/GGA message is used as information measuring a position, and the GNS/GGA message includes data acquisition time (i.e., position measurement time), longitude/latitude/altitude and the number of the satellites 51 used for calculating a position.

The GST message is statistical error information, and the GST message includes data acquisition time (i.e., position measurement time), axial deviation and angle of an error ellipse, and an error standard deviation of the measured longitude, latitude, and altitude.

The GSA message is information of the used satellite 5, and the GSA message includes information of satellite identification number used for calculating a position.

The GSV message includes the identification number, a satellite elevation angle, and a satellite azimuth angle of the satellites 51 used for a position measurement process.

The ZDA message is standard time information, and the ZDA message includes date (i.e., year, month, day) and time information of the world standard time when the position information was acquired.

In the present disclosure, the attribute verification data acquisition unit 19 acquires the attribute verification data including these messages, and outputs the attribute verification data to the attribute information acquisition unit 16. Since the GNS/GGA includes the positioning information (i.e., position measurement information) and the position information, the message includes the position information and the time information.

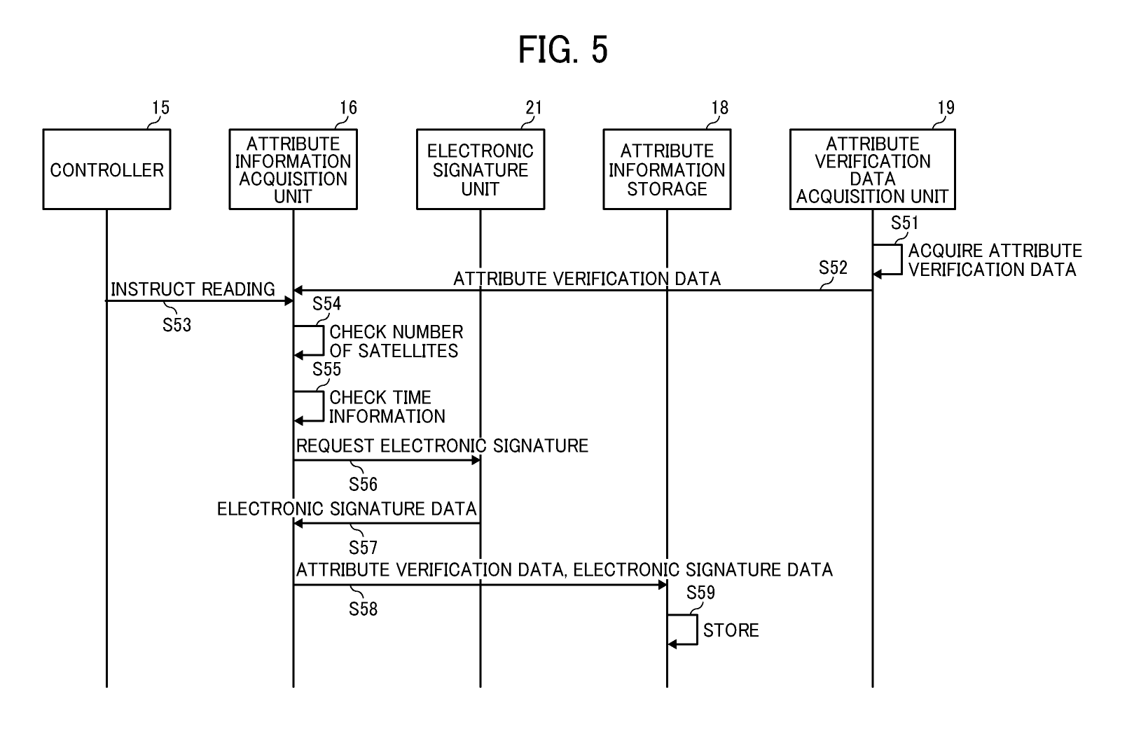

A description is given of an operation procedure of assigning or setting an electronic signature to attribute verification data by the image capture device 10 with reference to FIG. 5. FIG. 5 is an example of a sequential chart of assigning or setting an electronic signature to attribute verification data by using the image capture device 10.

S51: The attribute verification data acquisition unit 19 acquires a part or the entire of the message of NMEA 0183 received by the GPS receiver 119 as the attribute verification data at specific time points separated by a time interval set in advance by a setting process. For example, a user can set the time interval to acquire the attribute verification data.

S52: The attribute verification data acquisition unit 19 transmits the attribute verification data to the attribute information acquisition unit 16.

S53: The controller 15 instructs the attribute information acquisition unit 16 to read one or more specific terms from the attribute verification data at a pre-set timing, in which the pre-set timing is timing that the attribute verification data acquisition unit 19 acquires the attribute verification data.

S54: The attribute information acquisition unit 16 confirms that the GPS receiver 119 receives electromagnetic waves from four or more satellites 51 based on the messages of GNS or GCA among the attribute verification data acquired from the attribute verification data acquisition unit 19. This confirmation is performed because an error of position information, generated from the electromagnetic waves received from three or less satellites 51, becomes greater. If the GPS receiver 119 receives the electromagnetic waves from three or less satellites 51, the attribute verification data may be discarded.

S55: Further, the attribute information acquisition unit 16 confirms that the messages of each of GNS/GGA, GST, GSA, GSV and ZDA are used for one position measurement operation by checking whether the time information of each message matches or not. When the attribute information acquisition unit 16 confirms that the messages of each of GNS/GGA, GST, GSA, GSV and ZDA are used for the one position measurement operation, the attribute information acquisition unit 16 store the messages of GNS/GGA, GST, GSA, GSV and ZDA in the RAM 103 and/or the flash memory 104.

S56: Then, the attribute information acquisition unit 16 instructs the electronic signature unit 21 to assign an electronic signature to a set of the messages of GNS/GGA, GST, GSA, GSV and ZDA. If the electronic signature is unnecessary, the electronic signature is not assigned.

S57: The electronic signature unit 21 generates the electronic signature data from the set of messages of GNS/GGA, GST, GSA, GSV and ZDA, and transmits the generated electronic signature to the attribute information acquisition unit 16, in which the electronic signature can be generated by using a known method. For example, the electronic signature unit 21 generates a hash value (i.e., message digest) from the set of messages stored in the RAM 103 and/or the flash memory 104, and encrypts the hash value (i.e., message digest) by using a secret key to generate electronic signature data. If it is determined that reliability of the time information and the position information becomes high by encrypting not only the time information and the position information but also a hash value of other attribute information, it can be determined that reliability of other attribute information becomes also high.

S58: The attribute information acquisition unit 16 transmits the attribute verification data and the electronic signature data to the attribute information storage 18.

S59: The attribute information storage 18 stores the attribute verification data and the electronic signature data in the RAM 103 and/or the flash memory 104.

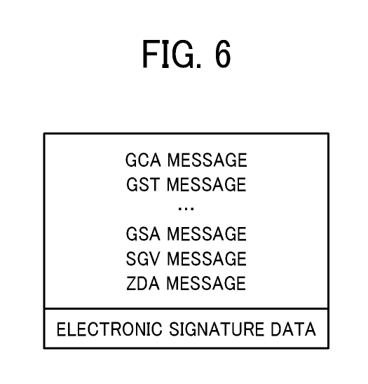

FIG. 6 is a schematic example of attribute verification data and electronic signature data. As described above, the attribute verification data (e.g., GNS/GGA, GST, GSA, GSV, ZDA) and the electronic signature data are associated with each other and stored.

FIG. 5 describes the method of acquiring the attribute verification data based on a request from the controller 15, but not limited thereto. For example, the attribute information acquisition unit 16 can acquire the attribute verification data independently from the controller 15, and then retains the attribute information.

### (Procedure of Image Capturing)

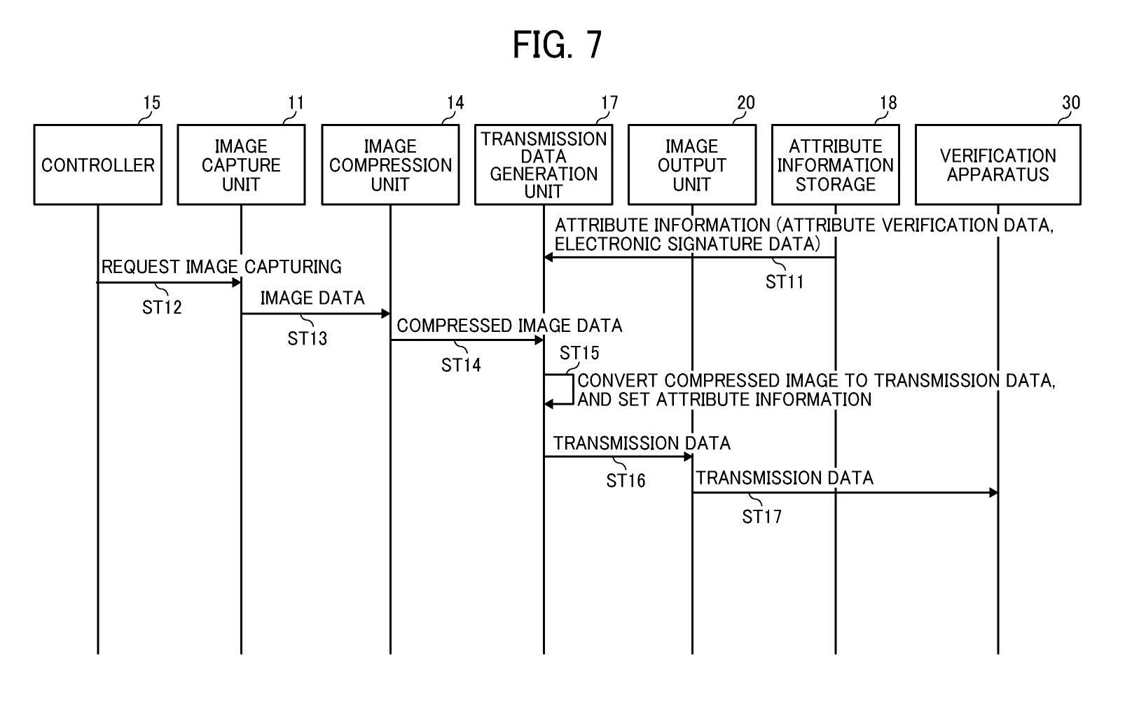

FIG. 7 is an example of a sequential chart of an operation procedure of the image capture device 10 when the image capture device 10 captures an image.

ST11: The attribute information storage 18 outputs the attribute verification data and the electronic signature data, processed and stored in the sequence of FIG. 5, to the transmission data generation unit 17 as the attribute information.

ST12: The controller 15 requests the image capture unit 11 to capture an image when timing for capturing an image has come. The timing for capturing the image occurs periodically in a case of movie image, and the timing for capturing the image occurs each time of a user operates the image capture device 10 in a case of still image.

ST13: The image capture unit 11 captures a scene and/or object, and generates image data. For example, the image capture unit 11 sequentially generates image data when capturing a movie image. Then, the image capture unit 11 transmits the image data to the image compression unit 14.

ST14: The image compression unit 14 compresses the image data to compressed image data, and transmits the compressed image data to the transmission data generation unit 17.

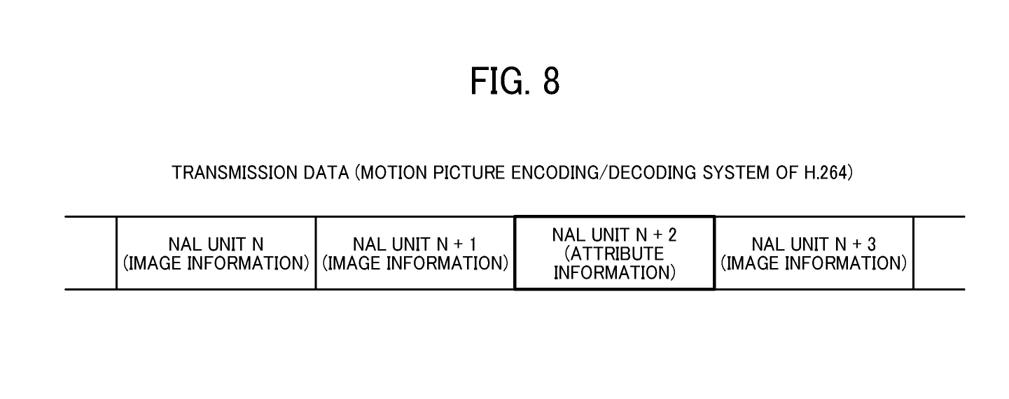

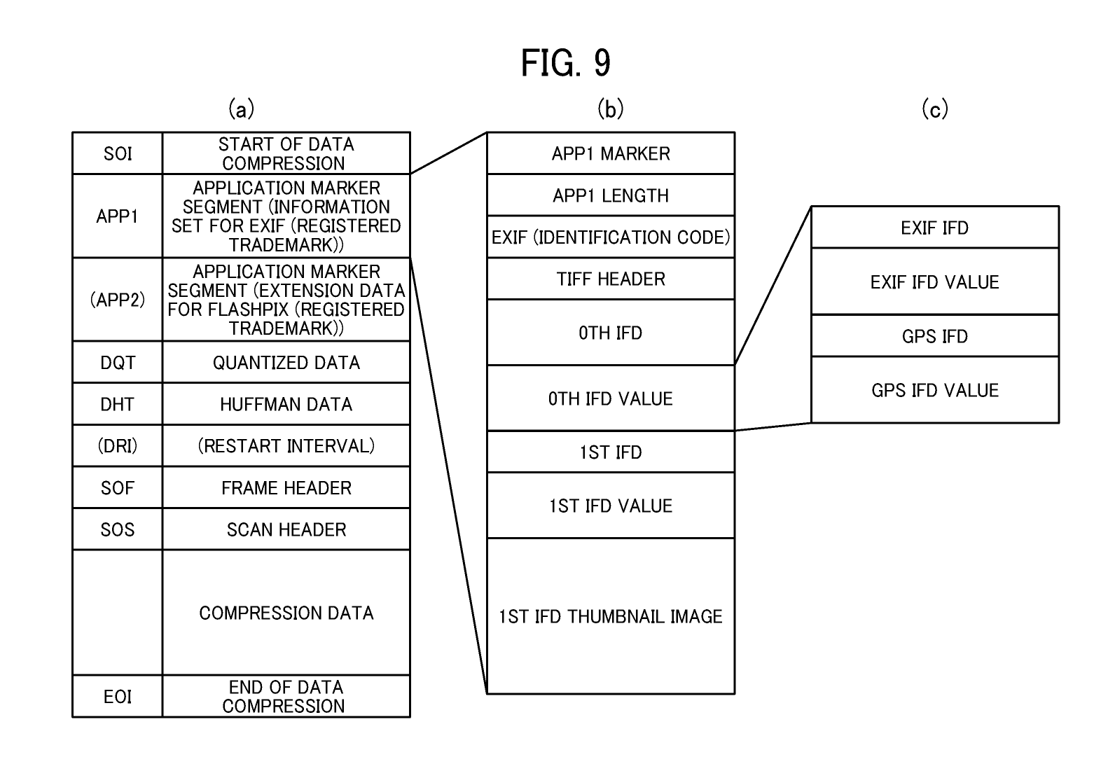

ST15: The transmission data generation unit 17 converts the compressed image to transmission data in a case of movie image, and sets attribute information to the transmission data, wherein the attribute information is not image data. FIG. 8 illustrates an example of transmission data of a movie image. FIG. 9 illustrates an example of transmission data of a still image, in which the transmission data generation unit 17 sets the attribute information to the image data by using, for example, EXIF format.

ST16: The transmission data generation unit 17 transmits the transmission data set with the attribute information to the image output unit 20.

ST17: The image output unit 20 transmits the transmission data to the verification apparatus 30. Further, instead of the verification apparatus 30, the image output unit 20 can transmit the transmission data to a client terminal that can be used to view the movie image, or an image storage server that can store the movie image. Further, the image output unit 20 can output the transmission data of the image to an external device of the image capture device 10 such as a portable storage medium such as SD card to store the transmission data by using a given file format.

### (Measured Data)

FIG. 8 illustrates an example of transmission data of a movie image applied with a motion picture encoding/decoding system of H.264. When H.264 is applied, the transmission data is divided in a unit known as Network Abstraction Layer (NAL) unit, in which the movie image (stream) is divided in a unit used for transmission (e.g., packet). The NAL unit is includes a video coding layer (VCL) NAL unit and non-VCL NAL unit. The VCL NAL unit is image data itself that is predicted, converted, quantized, and encoded with entropy. The non-VCL NAL unit stores a header and parameters used for decoding the image data of the VCL NAL unit. Specifically, the following SEI (Supplemental Enhancement Information), SPS (Sequence Parameter Set), PPS (Picture Parameter Set), and AUD (Access Unit Delimiter) are stored in the non-VCL NAL, unit, in which the SEI stores information used for managing a display and a buffer, the SPS stores information such as profile, width and height, and interlace of image data required for decoding the movie image, the PPS stores information required for decoding each of discrete picture (frame), and the AUD stores a partition of the NAL unit for generating one effective picture (frame).

The NAL unit is set with, for example; identification information such as “nal_unit_type” that indicates a type of information stored in the NAL unit. Therefore, a receiver side can easily identify information stored in the NAL unit is information of VCL NAL, unit (e.g., image data) or other information. In this disclosure, for example, the transmission data generation unit 17 stores the attribute information in the SEI of the non-VCL, NAL unit.

Therefore, by using the NAL unit, the attribute information (i.e., attribute verification data including position information and time information, and electronic signature data) can be set in the transmission data. Further, the setting frequency of the attribute information can be changed by a user.

### (Storing of Attribute Information of Still Image)

FIG. 9 illustrates an example of attribute information set for a still image. In an example case of FIG. 9, the transmission data generation unit 17 sets the attribute information to image data of the still image by using, for example, EXIF format, which is an example of file formats. In an example case of FIG. 9, the transmission data generation unit 17 converts image data by using the EXIF file format. Further, the transmission data generation unit 17 sets the attribute information (i.e., attribute verification data including position information and time information, and electronic signature data) in a part of image data file.

When the EXIF file format is applied, image data is recorded or stored by using Application Marker segment 1 (APP1) of PEG format. FIG. 9(a) illustrates an example configuration of PEG format. APP2 to APP15 store application specific information. Other fields include information used for decoding the image data at a receiver side.

FIG. 9(b) illustrates an example of a configuration of APP1. The APP1 Maker is two-byte data defined by FFE1, and the APP1 length is data length after the maker, and the data length is two bytes defined by x0002 to xFFFF (JPEG rule). The EXIF identification code stores a four-byte character string of EXIF plus two-byte of 0000. The TIFF header stores reference information indicating whether the recording or storing format of EXIF data is big endian or little endian. The subsequent IFDs mean a set of TIFF tags. For example, the 0th IFD includes the number of tags, a tag area, a pointer to a next IFD, and an area of tag value. The 1st IFD is also a set of TIFF tags, and stores attribute of a thumbnail image.

As illustrated in FIG. 9(c), the 0th IFD can store various tags, and 0th IFD can store EXIF IFD defining EXIF specific tag (e.g., image capturing conditions). Further, the 0th IFD includes a tag such as GPS IFD to store position measurement conditions of GPS. Further, when a tag number not defined by the EXIF standard is used, optional information can be attached to image data.

The transmission data generation unit 17 sets or writes the attribute information to the image data file by using the above described functions. For example, an engineer of a maker of the image capture device 10 can define a tag of SECURITY IFD in addition to GPS IFD. By storing the attribute information in the SECURITY IFD, the image capture device 10 can record or store the attribute information in the image data file as the data that can guarantee reliability of the attribute information. Further, other security information can be stored in the SECURITY IFD.

### (Verification Apparatus)

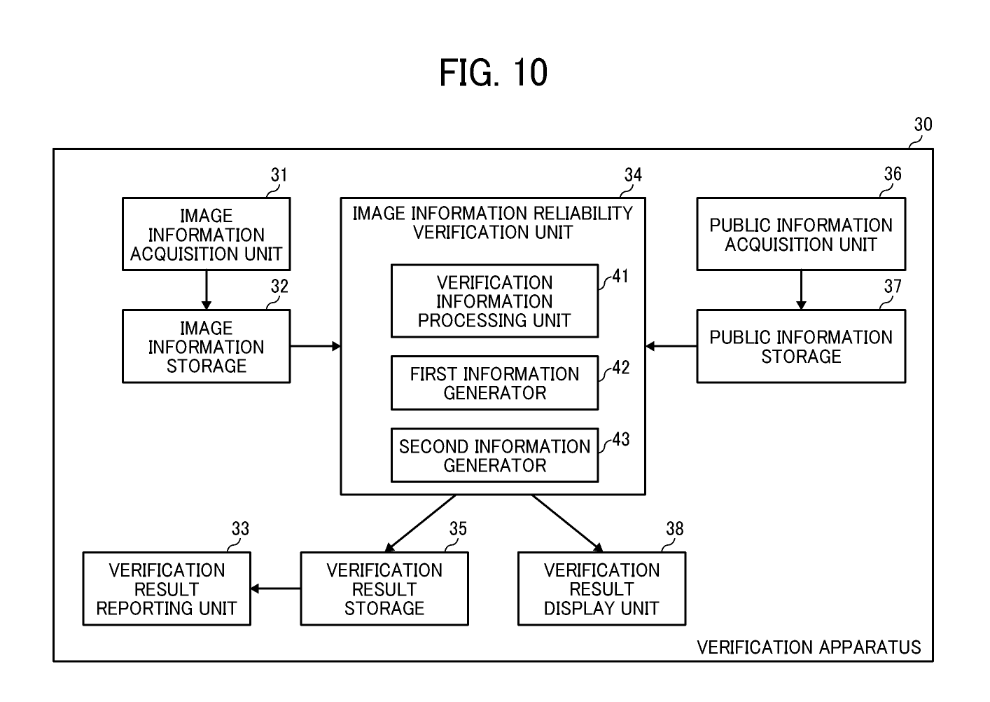

A description is given of a functional block diagram of the verification apparatus 30 with reference to FIG. 10. FIG. 10 is an example of a functional block diagram of the verification apparatus 30. As illustrated in FIG. 10, the verification apparatus 30 includes, for example, an image information acquisition unit 31, an image information storage 32, a verification result reporting unit 33, an image information reliability verification unit 34, a verification result storage 35, a public information acquisition unit 36, a public information storage 37, and a verification result display unit 38. In this description, the image information may be also referred to as the image data.

Each of these functional units can be implemented by using the hardware elements illustrated in FIG. 3. For example, each of these functional units can be implemented when a program loaded on the RAM 103 from the auxiliary storage device 204 are executed by the CPU 201 (FIG. 3) and the CPU 201 instructs an operation to the hardware elements illustrated in FIG. 3. Further, a part or the entire of the functional units can be implemented by a hardware circuit such as integrated circuit (IC), large scale integrated circuit (LSI), application specific integrated circuit (ASIC), field-programmable gate array (FPGA) and the like.

The image information acquisition unit 31 can be implemented when the CPU 201 (FIG. 3) executes programs and controls the communication unit 207, and the image information acquisition unit 31 acquires image information set with the attribute information from the image capture device 10. Further, instead of acquiring the image information through an online communication, the image information acquisition unit 31 can read image information stored in a memory.

The image information storage 32 can be implemented when the CPU 201 (FIG. 3) executes programs, and the image information storage 32 stores image data in the auxiliary storage device 204 and/or the RAM 203

The public information acquisition unit 36 can be implemented when the CPU 201 (FIG. 3) executes programs, and controls the communication unit 207, and the public information acquisition unit 36 acquires public information publicly available from the public information providing apparatus 50. Further, the public information acquisition unit 36 can read public information stored in a recording or storage medium.

The public information storage 37 can be implemented when the CPU 201 (FIG. 3) executes programs, and the public information storage 37 stores the public information in the auxiliary storage device 204 and/or the RAM 203.

The image information reliability verification unit 34 can be implemented when the CPU 201 (FIG. 3) executes programs, and the image information reliability verification unit 34 verifies the reliability of attribute information set to image information stored in the auxiliary storage device 204 and/or the RAM 203. For example, the reliability is verified mainly for the position information and the time information of the attribute information. Further, the image information reliability verification unit 34 includes, for example, a verification information processing unit 41, a first information generator 42, and a second information generator 43.

The verification information processing unit 41 acquires the attribute verification data including the position information and the time information from the attribute information.

The first information generator 42 estimates a position of the satellite 51 based on the position information set as the attribute information by applying the attribute verification data.

The second information generator 43 estimates a position of the satellite 51 at a specific position measurement time point based on the time information set as the attribute information by applying the public information.

The image information reliability verification unit 34 compares the two estimated positions of the satellite 51 to determine whether the position information and the time information have reliability.

The verification result storage 35 can be implemented when the CPU 201 (FIG. 3) executes programs, and the verification result storage 35 stores a verification result determined by the image information reliability verification unit 34 in the auxiliary storage device 204 and/or the RAM 203.

The verification result reporting unit 33 can be implemented when the CPU 201 (FIG. 3) executes programs, and the verification result reporting unit 33 reports the verification result to an external device or network.

The verification result display unit 38 can be implemented when the CPU 201 (FIG. 3) executes programs and controls the display unit 206, and the verification result display unit 38 uses the display 210 to display the verification result.

A description is given of a scheme of the verification process in the embodiment. The image information acquisition unit 31 acquires image information from the image capture device 10 via an online transmission configuration or an offline configuration, and the image information storage 32 temporally stores the image information in the auxiliary storage device 204 and/or the RAM 203. Further, the public information acquisition unit 36 acquires public information such as orbit information of the satellite 51 used for the GPS, and the verification-use information storage 37 stores the public information in the auxiliary storage device 204 and/or the RAM 203.

The verification information processing unit 41 of the image information reliability verification unit 34 extracts the attribute verification data including the position information and the time information required for the verification operation from the image information. The first information generator 42 calculates an estimated position of the satellite 51 used for measuring the position information, and an error range of the estimated position of the satellite 51. Further, the second information generator 43 calculates a position of the satellite 51 at a specific time point when the image capture device 10 measured the position information (i.e., specific position measurement time point) by applying public information (e.g. orbit information). If the position of the satellite 51 calculated from the time information set as the attribute information and the public information is within an existence-expected range of the position of the satellite 51 calculated from the position information set as the attribute information and the attribute verification data, the image information reliability verification unit 34 determines that the position information and the time information have higher reliability.

In a case of movie image, the verification apparatus 30 performs this determination process sequentially for each one of the satellites 51 used for calculating the position information, and verifies the reliability of the position information and the time information similarly.

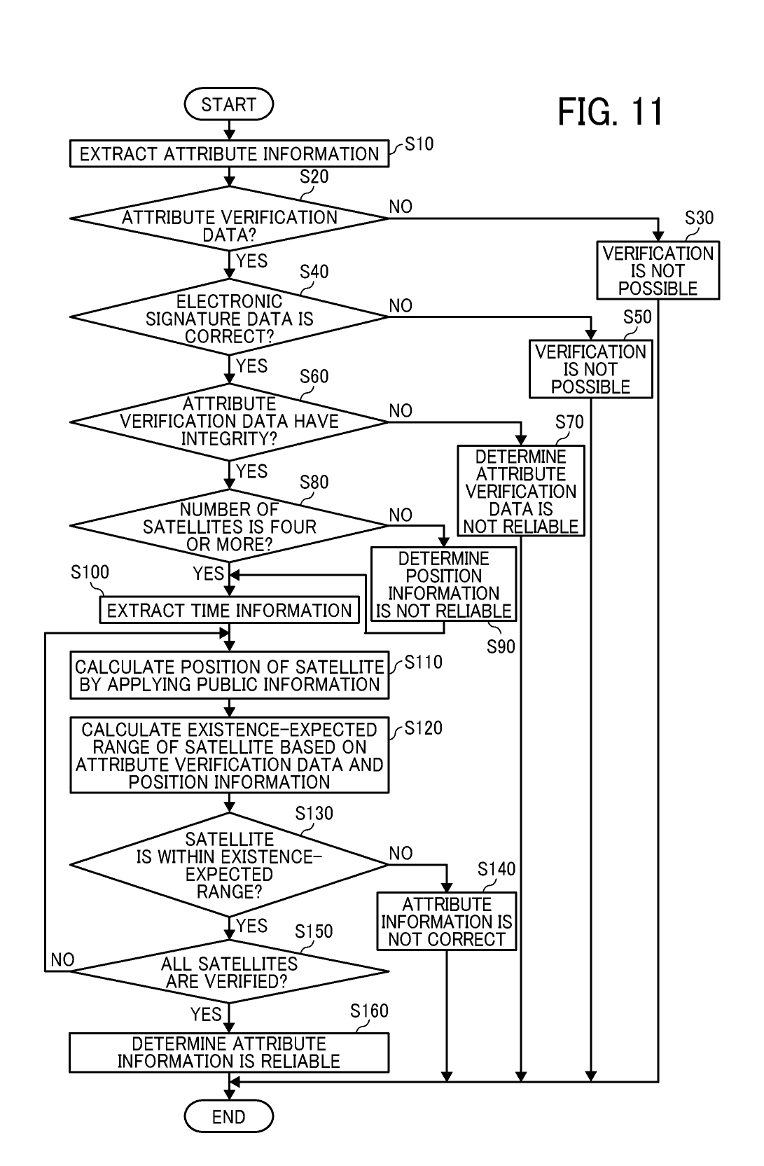

FIG. 11 is an example of a flow chart illustrating the steps of verifying the attribute information by the verification apparatus 30. The sequence of FIG. 11 starts, for example, when the image information acquisition unit 31 acquires image information.

The verification information processing unit 41 of the image information reliability verification unit 34 extracts attribute information from the image information (step S10). When a plurality of image information is to be verified, the image information can be verified by selecting one of the image information or the image information can be verified sequentially.

The verification information processing unit 41 determines whether the attribute information includes attribute verification data required for the verification operation such as messages of GNS/GCA, GST, GSA, GSV and ZDA (step S20). When the attribute verification data is not included (step S20: NO), the verification information processing unit 41 determines that the verification is not possible (step S30). Further, when the message is not included with an enough level, the verification cannot be also performed, and the verification information processing unit 41 determines that the verification is not possible (step S30).

Then, the verification information processing unit 41 determines whether electronic signature data is correct (step S40). Specifically, the verification information processing unit 41 compares a hush value calculated from the attribute verification data and a hush value that is obtained by decoding the electronic signature data.

When the two hush values do not match with each other (step S40: NO), the image information reliability verification unit 34 determines that the verification is not possible (step S50).

When the two hush values match with each other (step S40: YES), the verification information processing unit 41 determines whether the messages of GNS/GCA, GST, GSA, GSV and ZDA have integrity (step S60). For example, the verification information processing unit 41 checks whether the number of the satellites 51 is correct, whether a specific position measurement time point is the same, and whether information of the satellite 51 used for the measurement matches among the messages of GNS/GCA, GST, GSA, GSV and ZDA. Specifically, the verification information processing unit 41 checks whether the specific position measurement time point included in each of messages of GCA, GST, GSA, GSV, ZDA are the same or not. When the specific position measurement time point is the same, the verification information processing unit 41 can determine that each of the messages is used for measuring the same position information. Further, the verification information processing unit 41 checks whether the number of data included in GSA and GSV matches the number of the satellites 51. When the messages have no integrity (e.g., different specific position measurement time point are included in the messages, the number of data included in GSA and GSV do not match the number of the satellites 51), the verification information processing unit 41 determines that the attribute verification data is not reliable (step 570).

If the determination at step S60 is YES, the verification information processing unit 41 acquires a number of the satellites 51 used for the position measurement process from the message of GCA, and determines whether the number of the satellites 51 is four or more (step S80).

When the number of the satellites 51 is less than four (step S80: NO), the image information reliability verification unit 34 determines that the position information is not reliable (step S90). However, even if it is determined that the position information is not reliable (step S90), the subsequent steps are performed because when it is verified that the position information and the time information have higher reliability finally, even if the number of the satellites 51 is less than four and the position information may not be correct, it can guarantee that the position information and the time information are acquired from the satellites 51 that are less than four satellites.

Then, the verification information processing unit 41 extracts the time information from the attribute verification data (step S100). If the time information is critical information, the time information can be verified. For example, the time information can be acquired from the NTP server, and compared with the time information extracted from the attribute verification data

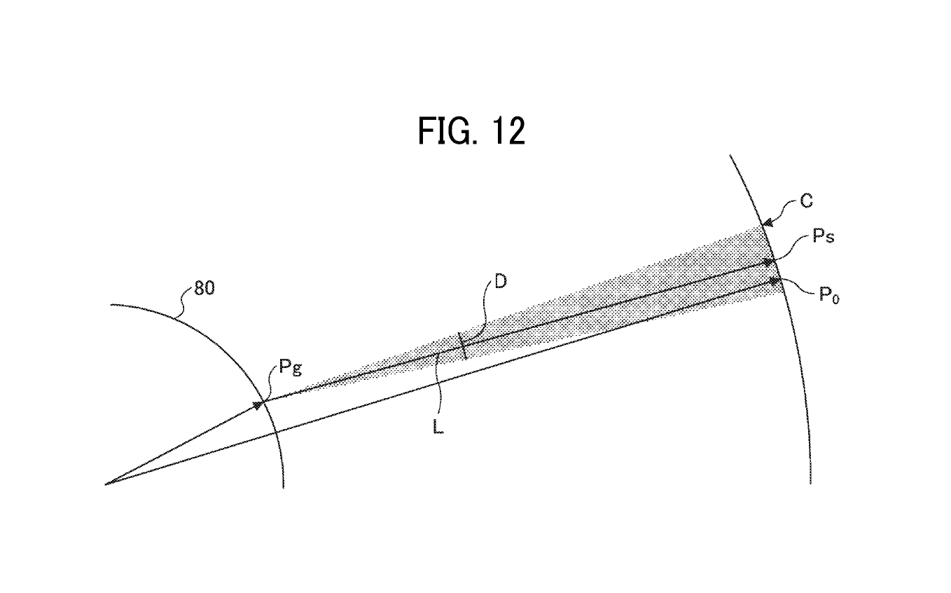

Then, the second information generator 43 of the image information reliability verification unit 34 calculates a position of the satellite 51 used for the position measurement process by applying public information (step S110). Specifically, the second information generator 43 can calculate the position of the satellite 51 at a specific position measurement time point from information of the specific position measurement time point included in the attribute verification data, and the public information. For example, the public information is orbit information of satellites used for GPS that is publicly available from one or more databases on a network. The detail will be described later with reference to FIG. 12.

Then, the first information generator 42 of the image information reliability verification unit 34 estimates the position of the satellite 51 at the specific position measurement time point based on information of the position information by applying the attribute verification data, and calculates the existence-expected range of the satellite 51 (step S120). The attribute verification data includes the position information measured on the earth (e.g., GNS or GCA), and a direction of the satellite 51 (e.g., GSV). Further, the altitude of the satellite 51 is known such as about 20,200 km when the GPS is used. Therefore, the position of the satellite 51 can be estimated from these information. Further, since GST includes an angular error (i.e., an angle indicating an error of the direction of the satellite 51 viewed from a position corresponding to the position information), the existence-expected range of the position of the satellite 51 can be obtained from the estimated position of the satellite 51. The detail will be described later with reference to FIG. 12.

Then, the image information reliability verification unit 34 determines whether the position of the satellite 51 estimated by applying the public information is within the existence-expected range of the satellite 51 at the specific position measurement time point, estimated by applying the attribute verification data (step S130).

When the position of the satellite 51 estimated by applying the public information is not within the existence-expected range (step S130: NO), the image information reliability verification unit 34 determines that the attribute information (i.e., position information and time information) is not correct (step S140).

When the position of the satellite 51 estimated by applying the public information is within the existence-expected range (step S130: YES), the image information reliability verification unit 34 determines whether the verification is performed for all of the satellites 51 included in the attribute information (step S150).

If the determination at step S150 is NO, the sequence returns to step S110. If the determination at step S150 is YES, the image information reliability verification unit 34 determines that the attribute information is reliable (step S160).

FIG. 12 schematically illustrates a position of the satellite 51 t a specific position measurement time point estimated by applying public information, and a position of the satellite 51 at the specific position measurement time point estimated by applying attribute verification data. Specifically, the public information includes information for specifying an elliptical orbit of the satellite 51 for each of every GPS weeks. The GPS weeks are cumulative weeks since the GPS time has been started synchronously with UTC (Coordinated Universal Time) at 0:00 on Jan. 6, 1980. Therefore, a position P0 of the satellite 51 at a specific time point can be calculated.

Further, the GNS message or GCA message includes information of a position Pg on the earth 80 that was measured by performing the satellite-based position measurement process. Further, the GSV message includes an elevation angle (i.e., 0 to 90 degrees) and an orientation angle (i.e., 0 to 359 degrees) indicating a direction of the satellite 51. Therefore, a straight line L indicating a direction specified by the GSV message can be obtained from the information of the position Pg on the earth 80. Further, the altitude of the satellite 51 is known about 20,200 km from the surface of the earth 80. Therefore, it can be estimated that the satellite 51 is present at a position Ps, distanced from the position Pg on the earth 80 for about 20,200 km on the straight line L.

Further, the GST message includes an angular direction error D (i.e., an angle indicating an error in a direction of the satellite 51 when viewed from a position corresponding to the position information). When the direction of the straight line L is deviated for the angular direction error D by setting the straight line L as the center, a circle having the center at the position Ps is obtained, and this circle becomes the existence-expected range C (see a hatched area in FIG. 12). The GST message includes an error ellipse having a long axis and a short axis with respect to the measured position information. The error ellipse is an error related to the position information Pg that was measured, and the error ellipse can be assumed as the error of the position of the satellite 51 when viewed from the measurement position. For this reason, the existence-expected range C can be assumed as the error of the position of the satellite 51.

Therefore, if the position P0 of the satellite 51 is within the existence-expected range C, the position Ps and the position P0 of the satellite 51 can be assumed as the same.

Specifically, the verification apparatus 30 estimates the position of the satellite 51 by performing the following two processes. As one process, the verification apparatus 30 estimates the position P0 of the satellite 51 from the time information set the attribute information and the public information that is publicly available. In another process, the verification apparatus 30 estimates the position Ps of the satellite 51 from the position information set as the attribute information and the attribute verification data. If it is assumed that the position P0 and the position Ps are the same, the positions of the satellite 51 obtained by performing the different processes become the same, with which the reliability of the time information and the position information can be determined higher. Further, since the two positions P0 and Ps are estimated by using the GPS, the verification apparatus 30 can determine that the attribute information (e.g., position information and time information) has been calculated and set by applying a reliable method having a higher reliability such as GPS.

As described above, when a position of the satellite 51, measured by a reliable institution and distributed to public, can be assumed equivalent to a position of the satellite 51 that can be calculated from the attribute verification data included in the attribute information, it can be determined that the position information and the time information used as the attribute information are set by a method having reliability, with which it can be determined that the position information and the time information used as the attribute information are not set by malicious person or malicious software. If four or more satellites 51 are used, it can precisely guarantee that the reliability is high because the attribute information is verified for all of the satellites 51.

Further, the verification result may be displayed on the display by the verification apparatus 30 or may be set in the image information. If the verification result is set in the image information, the reliability of the verification result can be increased when the public information (e.g. satellite orbit information) used for the verification operation is also set in the image information. Further, if the verification apparatus 30 assigns an electronic signature to the verification result to protect the verification result, the reliability of the verification result can be further increased.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

For example, in the above embodiment, the orbit information is provided from the public information providing apparatus 50, but not limited hereto, but the public information providing apparatus 50 can be configured to provide the position P0 of the satellite 51. Specifically, when the verification apparatus 30 transmits information of a specific position measurement time point included in the attribute information to the public information providing apparatus 50, the public information providing apparatus 50 calculates the position P0 and transmit the calculated position P0 to the verification apparatus 30, in which the verification apparatus 30 does not need to calculate the position P0 of the satellite 51.

Further, in the above embodiment, the motion picture encoding/decoding system for movie image employs H.264, but not limited thereto. For example, the movie image can be encoded by H.264/AVC, MPEG2, MPEG4, MPEG2/AVC, MPEG4/AVC, AVCHD, H.265 or the like.

Further, in the above embodiment, JPEG is employed as an example of the compression method of the still image, but not limited thereto. For example, TIFF, GIF, PNG can be employed. In this case, an appropriate file format is selected as the file format for setting the attribute information.

Further, in the above embodiment, it is verified whether the position information and the time information used as the attribute information are calculated by using the satellite-based position measurement process such as GPS, but not limited thereto. For example, the time information used as the attribute information can be provided from, for example, a NTP server, in which the verification apparatus 30 calculates the position P0 of the satellite 51 by using the time information provided from the NTP server, and also calculates the position Ps using the position information acquired from the GPS. If both of the calculated positions can be assumed as the same, it can be determined that the image was captured at a specific position indicated by the position information at a specific time matched to the time information. Therefore, it can be determined that the position information was measured by using the GPS, and it can be estimated that the time information is accurate even if it is not known whether the time information is provided from the NTP server, and it can be determined that the time information is acquired from a source having reliability.

Further, the time information provided by the NTP server can be verified. As to the National Institute of Information and Communications Technology (NICT) that provides the Japan domestic standard time via a web-site as open or public information, the time comparison method using the GPS is defined. Therefore, if a service provider operating the NTP server discloses its own clock accuracy based on the time comparison method, the processing similar to the above embodiment can be performed.

Further, the calculation of the position Ps of the satellite 51 can be performed by an external server instead of the verification apparatus 30, in which the verification apparatus 30 transmits the attribute information to the external server, and acquires the calculated position Ps from the external server.

In order to facilitate understanding of the processing by the image capture device 10 and the verification apparatus 30, example configurations illustrated in FIGS. 4 and 10 include various units according to the required processing. However, the present invention is not limited to the example configurations illustrated in FIGS. 4 and 10, but can be configured differently. The processing of the image capture device 10 and the verification apparatus 30 can be divided more various units according to the required processing. Further, it is also possible to divide the required processing by the image capture device 10 and the verification apparatus 30 by setting various processes in one unit.

In this description, the verification information processing unit 41 can be used as an acquisition unit to acquire information used for the verification process, and the public information acquisition unit 36 can be used as an acquisition unit to acquire public information from one or more service systems that provide various public information. Further, the first information generator 42 is used as an example of a first information processing unit, and the image information reliability verification unit 34 is used as an example of a determination unit. Further, the second information generator 43 2 is used as an example of a second information processing unit. Further, the position Ps is used as an example of a first position of a satellite, and the position P0 is used as an example of a second position of a satellite.

As to the above described embodiments, the verification system that can verify the reliability of attribute information included in attribute-information-added information can be provided.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

As described above, the present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

What is claimed is:

1. A verification system for verifying attribute information included in attribute-information-added information; comprising:
circuitry to
acquire attribute verification data from the attribute information, the attribute verification data to be used for verifying the attribute information;
acquire public information, to be used for verifying the attribute information, from an external service provider;
generate verification-target information to be used for verifying the attribute information based on the attribute information and the attribute verification data; and
determine reliability of the attribute information by comparing verification-use information calculated from the acquired public information and the verification-target information.

2. The verification system of claim 1, wherein the circuitry compares the verification-use information and the verification-target information to determine whether the attribute information is calculated by a given method.

3. The verification system of claim 1, wherein the circuitry generates the verification-use information based on the attribute information and the public information.

4. The verification system of claim 3,
wherein the attribute information includes position information and time information,
wherein the circuitry generates the verification-target information based on the position information and the attribute verification data,
wherein the circuitry generates the verification-use information based on the time information and the public information, and
wherein the circuitry compares the verification-use information and the verification-target information to determine whether the position information and the time information are calculated by the given method.

5. The verification system of claim 4,
wherein the attribute verification data includes information useable for calculating a first position of a satellite using the position information acquired by performing a satellite-based position measurement process,
wherein the verification-use information is a second position of the satellite that corresponds to the time information, and
wherein the circuitry compares the first position and the second position to determine whether the position information and the time information are calculated by the given method.

6. The verification system of claim 5,
wherein the public information includes orbit information useable for calculating the second position of the satellite that corresponds to the time information, and
wherein the circuitry calculates the second position of the satellite based on the time information and the orbit information.

7. An information processing apparatus to verify attribute information included in attribute-information-added information, comprising:
circuitry to
acquire attribute verification data from the attribute information, the attribute verification data to be used for verifying the attribute information;
acquire public information, to be used for verifying the attribute information, from an external service provider;
generate verification-target information to be used for verifying the attribute information based on the attribute information and the attribute verification data; and
determine reliability of the attribute information by comparing verification-use information calculated from the acquired public information and the verification-target information.

8. A method of verifying attribute information included in attribute-information-added information, comprising:
acquiring attribute verification data from the attribute information; the attribute verification data to be used for verifying the attribute information;
acquiring public information, to be used for verifying the attribute information, from an external service provider;
generating verification-target information to be used for verifying the attribute information based on the attribute information and the attribute verification data; and
determining reliability of the attribute information by comparing verification-use information calculated from the acquired public information and the verification-target information.
